(19) United States
(12) Patent Application Publication
(10) Pub. No.: US 2005/0108078 A1
(43) Pub. Date: May 19, 2005

(54) Methods for assessing institutional needs

(76) Inventors: Naala Royale, Baldwin, NY (US); Donald Buccelli, Langhorne, PA (US)

Correspondence Address: COZEN O'CONNOR, P.C., 1900 MARKET STREET, PHILADELPHIA, PA, 19103-3508, US

(21) Appl. No.: 10/712,816

(22) Filed: Nov. 13, 2003

(51) Int. Cl. G06F 17/60

(52) U.S. Cl. 705/10

(57) ABSTRACT

The invention is a method of assessing institutional needs. Particularly, the needs of institutional, such as university, food service needs can be assessed according to the inventive method. The method involves the steps of gathering information about the campus, segmenting the campus and day, evaluating needs of each segment against existing services, comparing needs and opportunities to available services, and preparing a report indicating proposed services.

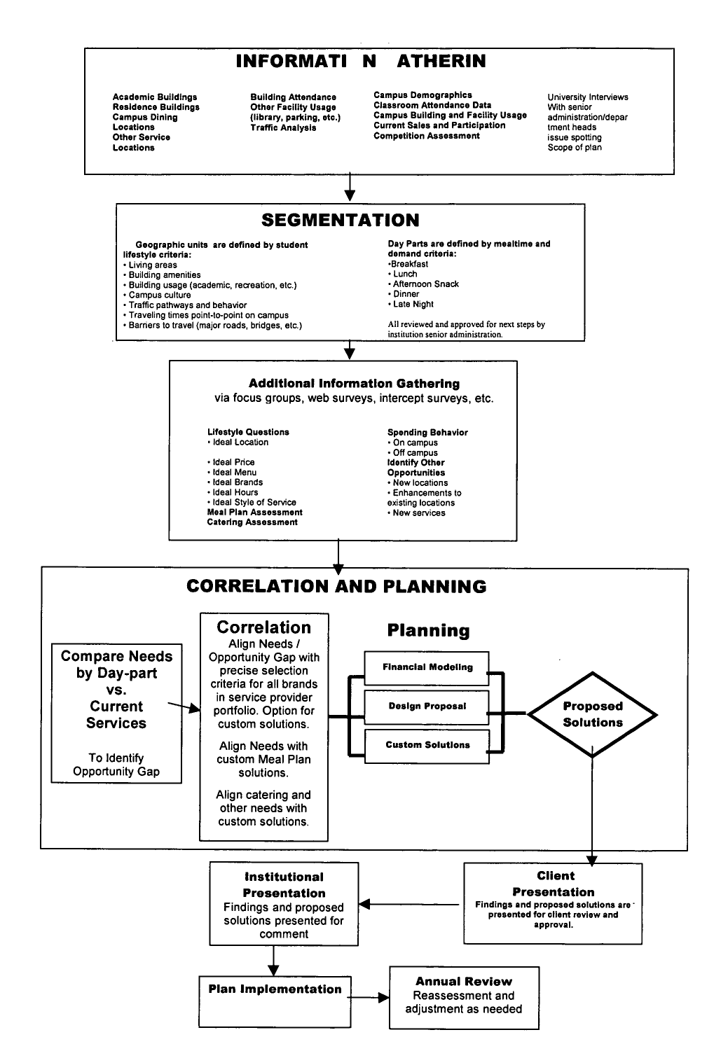

### FIELD OF THE INVENTION

The invention relates generally to methods for assessing institutional needs. More particularly, the invention relates to methods for assessing the needs of multiple populations in various geographic areas at different times of day.

### BACKGROUND OF THE INVENTION

Large institutions such as colleges and universities, as well as corporate campuses, have an interest in keeping their populations on-site. Those interests are many and varied, not the least of which are safety and revenue concerns. One way to ensure that people, whether faculty, staff, students, employees, visitors, or patrons remain on-site is to fulfill their needs and desires on campus, particularly their food and dining needs.

Traditionally, this has been difficult to do, particularly in an educational setting, because options were limited to mass-meal production. Indeed, the perception of value and quality is often lower than the reality. As a result, the institutional population often ventures off-site for greater variety and better quality, real or perceived.

Add to this the fact that in many instances, a single dining facility is expected to handle relatively large geographic areas with diverse populations and schedules. Out of necessity, the traditional dining hall is an exercise in compromise. Traditional institutional dining facilities simply do not account for the changing nature of the population surrounding the facility at various times of day.

Of course, the needs and desires of a given population are not limited to food, and other services may be affected by similar concerns or by altogether different concerns that should be assessed.

Accordingly, there is a need for a method of assessing the needs of such institutions to develop a plan for providing, updating, and/or expanding services based upon various population/ sub-populations factors.

### SUMMARY OF THE INVENTION

In certain embodiments, the invention comprises a method for assessing institutional community needs comprising the steps of:
a) defining at least a primary and a secondary characteristic used for segmenting the community;
b) segmenting the community by said primary characteristic into a target market;
c) further segmenting each target market according to at least one other characteristic;
d) for each further segmented target market unit:
   1) assessing the needs of the population therein;
   2) comparing needs to current services to identify each need not met by current services as an opportunity;
   3) correlating each opportunity to an available service.

In certain embodiments, the invention comprises a method for assessing institutional food-service needs comprising the steps of:
a) defining a plurality of target market units;
b) defining a plurality of day-parts;
c) for each target market unit at each day-part:
   1) assessing the needs of the population therein;
   2) comparing needs to current services to identify each need not met by current services as an opportunity;
   3) correlating each opportunity to an available service.

In some embodiments, each day-part is based on a traditional meal time.

In some embodiments, each day-part is modified in accordance with information regarding eating times of the subject population.

In other embodiments, target market unit is defined by grouping geographically proximate areas with similar populations and uses into a single unit.

In another embodiment, at least one target market unit is further divided into at least one sub-unit based upon a distinct use or population within a target market unit.

Yet another embodiment includes a step of producing a report indicating the correlated available services as recommended services after the correlation step,.

Yet another embodiment includes a method for assessing institutional food service needs comprising the steps of:
a) gathering information concerning at least one of:
   1) geography, including one or more of: location of buildings, roads, landscape features, traffic patterns, travel time between buildings;
   2) architecture, including one or more of: use, location, attendance rates, schedule of each building;
   3) population, including one or more of: location, time, purpose, schedules of individuals;
   4) needs, including one or more of: meals, grocery, food types, services, etc.
   5) existing services, including one or more of: location of services, on-site services, off-site services, satisfaction, and type of services;
b) defining a plurality of day-parts based on traditional meal-times, optionally modified by information gathered
c) defining a plurality of target market units, and optionally sub-units, based upon information gathered;
d) for each target market unit at each day-part:
   1) assessing the needs of the population therein;
   2) identifying each need not met by current services as an opportunity;
   3) correlating each opportunity to an available service
   4) reporting each correlated available service as a recommended service.

### BRIEF DESCRIPTION OF THE DRAWINGS

Those reasonably skilled in the art will understand that the drawing FIGURE, described below, are for illustrative purposes only. The drawing FIGURE is not intended to limit the scope of the invention in any way. Like reference numerals indicate like elements throughout the drawing FIGURE.

The sole FIGURE is a flowchart of the various steps of a method according to one embodiment of the invention.

### DETAILED DESCRIPTION

It is to be understood that both the foregoing general description and the following detailed description are exemplary and explanatory only and are not restrictive of the invention, as claimed. In this application, the use of the singular includes the plural unless specifically stated otherwise. In this application, the use of “or” means “and/or” unless stated otherwise. Furthermore, the use of the term “including”, as well as other forms, such as “includes” and “included”, is not intended to be limiting.

The section headings used herein are for organizational purposes only and are not to be construed as limiting the subject matter described. All documents, or portions of documents, cited in this application, including but not limited to patents, patent applications, articles, books, and treatises, are hereby expressly incorporated by reference in their entirety for any purpose.

Although the methods described herein are applicable in a variety of institutional or corporate settings, the educational setting, particularly university or college settings, will be discussed in detail herein. This discussion is by way of example and is not intended to limit the scope of the invention. The university setting is ideal for this discussion, because typically, it involves a well-defined geographic area (campus), almost as equally well-defined geographic sub-units (academic areas, housing areas, athletic areas, etc.), a well-defined recurring population (students, faculty, staff), and sub-populations, while maintaining, if not embracing, diversity. With these various groups, differing needs often present themselves at specific times and locations. Here, we will discuss the university campus food service setting.

In the context of university food service, to keep students, faculty, staff, and visitors (i.e. potential consumers) on campus it is necessary to satisfy more than just the basic need for sustenance on campus. Today the campus population is full of sophisticated, and often mobile, consumers rather than captive ones. To satisfy such a population adequately and efficiently, their needs, desires, habits, schedules, location, and numbers, among other things, should be taken into account.

Developing a plan for addressing, satisfying, and surpassing these needs involves detailed information about the campus and its population, sub-populations, culture, and sub-cultures. When issues such as location, attendance and use of buildings and facilities along with campus geography and demographics are known, the needs of the population and sub-populations can be addressed adequately at each location and time.

Thus, in some embodiments, extensive, deep-probing information gathering is undertaken to discover where potential consumers are throughout the day, and what their needs are. To undertake such a monumental information gathering task, results are best if nearly every sector of the university population is involved.

Once the information is gathered, it can be parsed and supplemented if needed. University campuses are busy, ever-changing places. Thus, perhaps among the most important pieces of information to know about any particular campus are 1) where are the consumers? 2) when are they there? 3) what are they doing? 4) what are their needs at this time and location? The gathered information is parsed and manipulated to yield the answers to these questions.

In particular, some of the information is used to define target market units and sub-units within the campus based upon a primary characteristic. In the university, food service setting, the primary characteristic is evaluated as a neighborhood, and is most easily visualized as a geographical unit. These units are not defined solely by geography, but also by the activities and populations within them. Additionally, the information is used to define specific, and preferably meal-associated, day-parts that are used as a reference for a consumer's location throughout the day. Knowing what potential consumers are doing in certain locations throughout the day helps evaluate what kinds of habits the consumer has, how much time is available for eating (whether dining or snacking). In other, non-university institutions and in non-food service arenas, the primary characteristic may differ significantly from the university setting. For example, in some business models user frequency may be a primary characteristic rather than geography or neighborhood.

Segmentation is the process of dividing the market into distinct subsets of customers who behave in the same way or have similar needs. Therefore, each group becomes a target market whose needs are met by identifying the right products and services. For dining services, segmentation is used to understand dining and lifestyle support needs of various groups on campus and helps identify the right mix of facilities, menus, non-food services, and meal plans to meet the needs and idiosyncrasies of each segment during each day-part.

Because of the complex nature of the campus community, it is no longer sufficient to segment the on-campus population into residents, commuters, and faculty/staff, as has been done traditionally. Research findings substantiate the importance of the convenience factor in students' eating patterns. Students' decisions on where and what to eat are driven largely by the proximity of the service locations to the geographic area where they live on or off campus, work, attend classes, or even where they park their car. As a result, the first and most important step in the master planning process is to segment the population by geographic clusters, identifying the distinct unit on campus with very distinct needs. Examples of geographic unit distinctions include: apartment vs. suite-style residence halls, lower-classmen versus upper-classmen residence halls, “resimuter” housing (off-campus housing around the perimeter of the campus) versus true commuter housing, undergraduate classroom areas versus separate graduate, law, or medical school areas.

Today's campus lifestyles shun traditional three daily meals in favor of more casual, but more frequent eating patterns. Assessing when and where these needs can be addressed brings the service to the consumer rather than luring the consumer to the service. Periodic review of the campus lifestyle and subcultures ensures that the service will keep pace with demands. Thus, in the food-service model, the target market is further segmented by the secondary characteristic of day-part, roughly coinciding with meal and snack times.

Finally, directly asking consumers their needs provides invaluable insight on desired services in real time. Thus, from the knowledge gained, for each time and location, the needs of the population can be assessed and compared to existing services to determine where opportunities exist to supplement or improve existing services or to create additional services. These needs and opportunities then are easily tracked within the target market unit by day part.

Once the needs and opportunities are assessed, the opportunities are correlated to services available from the provider. This correlation can be done in any number of ways. The process may be facilitated by using a computer to compare needs-based criteria with features of available services. Available services are typically selected from the service provider's list of services, such as sit-down dining facilities, food court operations, coffee bars/shops, lunch/snack carts, convenience/grocery stores, and specialized services such as catering and vending. Within these there may be a variety of choices such as fast food, pizza, vegetarian, Chinese, sushi, juice bars. Customized solutions are also available.

In correlating the needs of the target market unit by day-part, the food service provider compares its available brand selections to align the needs or opportunity gaps with precise selection criteria for all brands (national or otherwise) in the service provider's portfolio. Custom solutions may also be provided. In the university setting, many students are on meal plans and thus, each target market units may benefit from a custom meal plan to encourage participation in on-campus dining. Catering and vending and other custom services are also investigated as needed. The final proposed implementation plan also takes into account financial models, design (aesthetic and functional) solutions, and any custom solutions. The final proposal should be reviewed by campus leaders and revised if necessary. Those skilled in food service will also be able to guide decisions as to which services need immediate attention or will offer the greatest initial impact.

Thus, by taking active steps to define various populations, geographic areas, and times in a campus, the needs of specific groups of consumers in specific locations at specific times can be assessed to better address their needs in an effort to satisfy them and consequently keep them on campus. Dividing the campus and the day, in particular, allows the needs of a given sub-population in any target market unit or subunit at a certain day-part to be more easily assessed and met once it is known how large the population is and what they want. Another advantage of the method is that needs and desires of the population are broken down for easy comparison with and correlation to available services. Once the correlation is made, a plan can be prepared implementing various services to address the needs of each sub-population and the campus as a whole.

Importantly, the campus should be surveyed and questioned at regular intervals so that the constantly evolving needs of the consumer base may be assessed. In this way, the offered services can be modified as needed to accommodate the needs of the campus as they develop. Semi-annual reporting is preferred.

One key to the success of determining the needs of the population and addressing them is having information about the campus and its population. This information is used to define and segment the institution in several ways.

In some embodiments of the invention, such information may be provided to the food service-provider by the university or by other third party sources. In other embodiments, the food service-provider conducts its own information gathering either as a stand-alone project or to supplement information obtained from other sources. In some embodiments, information concerning various aspects of the campus and campus life is gathered directly from the campus population and records. In still other embodiments a combination of two or more of these approaches may be used.

Some useful techniques in gathering information which may be used include focus groups, internet surveys, written surveys, intercept surveys, group discussions, facility questionnaires, campus records, etc. Formalized approaches allow for detailed information gathering, while impromptu intercept surveys may actually reveal the interests of potential consumers in real time. Thus, both techniques can be used in combination to fully assess the needs of the community. In some embodiments, information may be gathered in one initial step or two distinct phases. As seen in the FIGURE, a first phase of information gathering can be designed for segmenting the campus into distinct target market units and day parts. Once these are established, more pointed surveying tools can be used to assess needs within each unit. These intensive information gathering sessions are preferably supplemented by information gathered in working and visiting the campus throughout the process. Information gathering can be an ongoing process, used to tweak the proposal and suggestions offered.

By way of example and not of limitation, information may be gathered concerning the geography of the campus; the architecture on campus; the needs expressed by the campus population and sub-populations; and the existing services.

Geography includes, by way of example and not limitation, natural features of the campus, such as hills, landscaping, and other features or potential obstacles, locations of buildings, roads, rights of way, traffic patterns, and even travel times between locations. Campus architecture defines, again by example and not as a limitation, the various buildings on campus by their usage, e.g. housing, academic, their attendance rates, scheduling, hours of operation, etc. Number, location, time, purpose, and schedule of individuals, among other things define the population and sub-populations. Of course, some of these features are interrelated and affect others. Some features are best observed and evaluated by direct observation.

For example, a population or sub-population can be defined as 1100 students, in the academic unit, during the breakfast day-part, generally in the area for the purpose of attending classes. If enough information is collected, it may even be possible to know useful details such as, for example, during the breakfast day-part (e.g. 7-11 am), the number of students who eat breakfast before classes, the number of students in the academic unit that have at least 1 hour between two classes, or what they typically eat (or would like to) at this time and location. Such detailed information is extremely useful in developing a comprehensive plan for food services.

Segmentation is accomplished in two major ways. The campus is divided into two or more smaller target market units and the day is divided into two or more day-parts.

From the information gathered, the campus is divided by defining two or more target market units and/or sub-units within the geography of the campus as a whole. Although geography can play a major role in defining these areas, social factors, such as building usage, attendance, and other factors weigh into the definition. For example, although two buildings might be geographically proximate each other, one might be a housing complex and the other a science building. Because each has a use quite different from the other, they might properly be separated to address the particular needs of each at different times.

Each target market unit is defined based upon information gathered previously. While geography is a natural and key factor in defining these units, it is not the only factor. For example, some streets, landscape features, or even buildings provide logical boundaries that might be difficult to ignore. On the other hand, where no physically logical boundary exists, a difference in usage or attendance of adjacent areas, or other factor, could establish a boundary. Thus, geography along with other factors is used to define target market units, and, if applicable, sub-units within a unit.

Each day is divided into several day-parts. Preferably each day-part is defined around a traditional mealtime. Typical day-parts might include a breakfast day-part, a lunch day-part, a dinner day-part, and a late-night day-part, which correspond to specified time periods normally encompassing those meals. Of course, the day-parts need not stand on tradition and may be adapted to the needs of the campus generally or even by target market unit. For example, a late morning snack day-part might be useful rather than lengthy or expanded breakfast or lunch hours.

Thus, the campus and the day are divided into more manageable size based at least in part on the information gathered about the campus and its population.

Once the campus is divided into target market units and the day-parts defined, the needs of the populations present in each target market unit at each day-part are assessed. It is at this point that the information gathered is unified to produce a meaningful implementation plan.

Having divided the campus into smaller target market units and time periods, the information gathered is again processed to reveal the needs and desires of each target market unit throughout the day. Once these needs are known, they are compared to available services in several ways. In some embodiments, these needs are compared with existing services to identify opportunity gaps to improve existing dining facilities. In other embodiments, especially new campuses, the needs are compared to a number of available services to develop a new plan. In most cases, a combination of the two will be used to improve existing dining facilities and to present new dining options where they had not previously existed.

The correlation of needs to services can be done manually by food service specialists familiar with the campus, the collected data, and the available services. This process may be facilitated by use of a computer which houses information about the services available from the food service provider and the information gathered about the campus. Preferably, standardized descriptors for both needs and available services can be employed, at least in part, to facilitate matching via the computer.

During the information gathering and parsing phases, each target market unit and day-part reveal what style of dining is needed, as well as what types of food are preferred. These are then compared to the dining style and food types of the available services. For example, during main meal times some locations will support a full food-court with a variety of franchise and non-franchise food services. Other campuses or even a different target market unit in the same campus might have a greater demand for a cafeteria type food service in the same day-part. At times not normally associated with the main meal, the preferences can vary even more greatly with target market units. For example, in a science and engineering unit there may be decreased demand for food services in the afternoon, between 1 and 5, because much of the population in that area can be found in afternoon laboratory courses. In contrast, over in a liberal arts unit, students in the same time period may be walking between classes or even have time between two classes for snacking or even a meal. With respect to food type, this again can be determined from information gathered about the target market unit. One unit may have a high demand for sushi, while another may require more pasta and salads. Of course, it is probable that there will be demand for some similar services regardless of target market unit and in some cases day-part.

The correlating step aligns consumer needs with the available services. The result of the correlation is then reviewed to determine whether some or all of the available services should be offered. This final step is preferably done with consultation with the campus leadership.

Understanding the mission and goals of the institution and its community play an important role in determining the scope and objective of services on site. Institutional goals drive decisions relative to the types of services provided, styles of service (community dining rooms, coffeehouses, quick-stop convenience outlets), customized services (athlete dining, health and wellness programs), menu planning, nutrition awareness, and other programs and services. This understanding is best gathered through in-depth interviews of administration leaders. The finding from these interviews, combined with directional oversight of senior community leadership, help shape the overall recommendations derived from the consumer research.

For example, qualitative and quantitative data was reviewed to assist in revealing insights and ideas in developing recommendations relative to student dining behaviors and decisions on a particular university campus. Several research methods and tools were used while completing this study, including: Neighborhood Segmentation analysis, Maritz Voice of the Customer survey data, ICR Share of Stomach survey data, focus group discussions, intercept surveys, custom e-mail surveys, and general demographic, operational, and financial analysis. Other types of survey tools may be used. For example, the teachings of U.S. patent Ser. No. 09/475,159, hereby incorporated by reference, may provide a useful tool in evaluating the lifestyle and lifestyle changes of the campus.

Neighborhood segmentation analysis is the process of collecting information and subdividing the campus into distinct target market units as described herein. Maritz Voice of the Customer Survey was conducted by Maritz Research, St. Louis, Mo. to assess student preferences. In particular, the survey is used to assess the strengths and weaknesses of particular facilities form the consumer's vantage point, areas of most import to the consumer, and specific preferences of the consumers. Specific focus points are the perception of food quality, variety, value, facility cleanliness, customer satisfaction, recommended improvements, trends, etc. The survey also affords an opportunity to assess the demographic profile. The ICR “Share of the Stomach” survey was conducted to provide a qualitative exploration of student dining markets across the nation. The study evaluates when, where, and what students eat, factors impacting dining decisions, prevailing attitudes about meals, and unmet needs and desires.

Studies of this nature allow an assessment of the individual campus and a basis for comparison on a nationwide level. The studies are complemented by student focus discussions, intercept surveys, e-mail surveys, and in-depth interviews.

In view of gathered information and data about a particular campus, nine separate geographic units are defined. These include 1) a residential unit including Greek housing, 2) an academic unit including a graduate business school, 3) freshman dormitories, 4) College house with athletics, 5) Law unit, including housing, 6) science and engineering, 7) off campus Upper-class housing, 8) Medicine and biology, and 9) athletic facilities.

In the first unit, about three thousand undergraduate students and 60 graduate assistants live in six university-owned residences in this geographic unit. Most residence halls in the area have at least minimal kitchen facilities ranging from micro-fridges to suite kitchens to common kitchens. In this area, almost 500 freshman live with mandatory meal plans and 1000 upper classmen have voluntary meal plans. Fraternity and sorority housing is also present in this target market unit. This area is also frequented by lunch trucks along some of the major streets which also include retail convenience and pharmacies as well as a grocery store. Several nearby competitors, ranging from a fast food chain to a local buffet are within three minutes walking distance. This area houses one dining facility. Currently the facility offers residential dining with an all-you-care-to-eat style along with one national brand sandwich franchise, and two food service brands for pizza and salad. Express breakfast and lunch services provide on the go type selections.

Student surveys revealed that they are likely to eat or snack at five periods throughout the day. Traditional meals such as breakfast, lunch, and dinner as well as an afternoon and late-night snack are important to most students in this unit. Thus, these are the established day-parts.

Through this analysis, immediate gaps are readily visible, because the campus facility does not offer late night snack, and only one option during the afternoon snack day-parts. Regardless of day-part, students venture off campus for take-out and made-to-order options, and also for grocery items to prepare food in their apartments. Each day-part has individually identified needs and opportunities.

Although many students skip breakfast, those that do eat, typically grab finger foods such as fruit, breakfast bars, muffins, etc. to eat on the go. A few eat cereal in their rooms. Coffee and juice are also important in this day-part. There is an expressed need for hot breakfast sandwiches.

At lunch time, student prefer to use meal plans or other college sponsored payment plans. Most students have time in their schedules to eat lunch and socialize. The students expressed a need for both sit-down style dining and on the go selections. Variety of selection is important, including salads, sandwiches, and pizza. Students also expressed a desire for brand franchise Mexican and or chicken. The survey data reveals that lunch actually begins at 10:30 a.m.

Afternoon snack is a period between lunch and dinner during which student needs are largely unfilled. Typically students carry small snacks such as yogurt, cookies, fruit, and candy. The brand sandwich franchise is open, as are several off campus competitors.

At dinner time, students desire a place to sit with friends to eat and socialize. Food preferences are for chicken, home-style meals, and ethnic cuisine. Students with available kitchens look for grocery style meal replacement including easily prepared items like macaroni and cheese. Food delivery is often an option. Seating at some popular areas is limited.

Late night needs are wholly unfulfilled on-campus. Any late-night snacking, i.e. after 8 p.m., is done in the students rooms or off-campus. Students like take-out, ice-cream, grocery snacks, and sandwiches. They desire a place to socialize with friends.

From the information-gathering phase, food preferences at each day part are known and ranked. Armed with this information, the opportunities, unfilled needs, and desires of the students are compared to services available from the food service provider. The strong desire for made-to-order foods, and a poor perceived price/value perception is a match for the food service provider's program bringing in a complete salad bar with made to order salads, deli stations, homemade bread, and made-to-order individually prepared menu selections. Vegetarian or vegan options are also available. This plan can be instituted in a redesigned space to facilitate socialization during the dining hours. Expanded express services are also warranted at this particular location. The current express service will be expanded to offer hot selections, and to accept university sponsored meal plans. Finally, due to the Greek population in this area, the food service provider recognizes the need to provide a custom meal plan designed for the needs of the Greek population who live in the area.

The food service provider has available a number of national brand services and food service brand services as well as dining services with which to fulfill the needs of this unit and to provide new services to fulfill unmet and underdeveloped areas. For example, the survey data indicates a desire for national brand Mexican or chicken in the dining facility. This particular opportunity is correlated to one of the national franchises specializing in chicken that is available to the food service provider. Accordingly, the implementation plan will include this option. Correlating the students snacking needs in the newly defined afternoon snack and late night snack day-parts, a food service brand ice-cream shop can be included to serve up desired smoothies, shakes, and ice-cream. This particular option can also be made available during other day-parts as an added value item.

Another unmet need is the need for convenience and grocery items. Again, this need is correlated to a retail food store in the food service provider's arsenal of services. By introducing this option, the university can offer students a more convenient and possible safer alternative to off-campus shopping while collecting revenue which previously had gone to off-campus groceries.

Finally, the data gathered suggests that different hours could be beneficial. Accordingly, the food service provider recommends expanded breakfast hours, and later evening hours.

The needs of each target market unit is similarly assessed and compared to the food service provider's list of available services to develop a plan to address and unmet needs or opportunities.

Once each individual geographic unit is assessed, the food service provider may then reassess in view of the overall campus picture, fine-tuning the overall campus plan to avoid any unnecessary duplication or to fill any obvious gaps in service.

As with the information gathering phase, campus input is key to the success of any implementation plan. Accordingly, the campus leadership should have input, wherever possible, on which choices of services to use and in the final implementation of any plan.

The above-description is meant by way of example and is not intended to limit the scope of the invention as defined by the claims below.

1. A method for assessing institutional needs comprising the steps of:
a) defining at least a primary and a secondary characteristic used for segmenting the community;
b) segmenting the community by said primary characteristic into a target market;
c) for each target market unit:
1) assessing the needs of the population therein;
2) comparing needs to current services to identify each need not met by current services as an opportunity;
3) correlating each opportunity to an available service.

2. The method according to claim 1, wherein following step b), the target market is further segmented by a secondary characteristic, wherein step c) is carried out within each of said further segmented target markets.

3. A method for assessing institutional food-service needs comprising the steps of:
a) defining a plurality of target market units;
b) defining a plurality of day-parts;
c) for each target market unit at each day-part:
1) assessing the needs of the population therein;
2) comparing needs to current services to identify each need not met by current services as an opportunity;
3) correlating each opportunity to an available service.

4. The method of claim 3 wherein each of said plurality of day-parts is based on traditional meal times.

5. The method of claim 4 wherein each of said plurality of day-parts is modified in accordance with information regarding eating times of the subject population.

6. The method of claim 3 wherein each target market unit is defined by grouping geographically proximate areas with similar populations and uses into a single unit.

7. The method of clam 3 wherein at least one target market unit is further divided into at least one sub-unit based upon a distinct use or population within a target market unit.

8. The method of claim 3 further comprising, after the correlation step, the step of producing a report indicating the correlated available services as recommended services.

9. A method for assessing institutional food service needs on a campus comprising the steps of:
a) gathering information concerning at least one of:
1) campus geography;
2) campus architecture;
3) population;
4) food service needs and desires;
5) existing services;
b) defining a plurality of target market units, and optionally sub-units, based upon information gathered;
c) defining a plurality of day-parts based on traditional meal-times, optionally modified by information gathered; and
d) for each target market unit at each day-part:
1) assessing the needs of the population therein,
2) identifying each need not met by current services as an opportunity,
3) correlating each opportunity to an available service, and
4) reporting each correlated available service as a recommended service.

10. The method of claim 9, wherein said information on campus geography includes one or more of: location of buildings, roads, landscape features, traffic patterns, travel time between buildings, and obstacles or impediments to travel.

11. The method of claim 9, wherein said information on campus architecture includes one or more of: use, location, attendance rates, and schedule of each building.

12. The method of claim 9, wherein said information on population includes one or more of: location, time, purpose, and schedules of individuals.

13. The method of claim 10, wherein said information on food service needs and desires includes one or more of: dining style, meal-type, grocery, food types, desired services, desired eating and snacking times, and food preferences.

14. The method of claim 9, wherein said information on existing services include one or more of: location of services, on-campus services, off-campus services, satisfaction, and type of services.
